(19) United States
(12) Patent Application Publication
(10) Pub. No.: US 2013/0028266 A1
(43) Pub. Date: Jan. 31, 2013

(54) RESPONSE MESSAGES BASED ON PENDING REQUESTS

(71) Applicants: Michael L. Ziegler, Roseville, CA (US); Steven Glen Jorgensen, Newcastle, CA (US); Jonathan M. Watts, Folsom, CA (US)

(72) Inventors: Michael L. Ziegler, Roseville, CA (US); Steven Glen Jorgensen, Newcastle, CA (US); Jonathan M. Watts, Folsom, CA (US)

(21) Appl. No.: 13/194,037

(22) Filed: Jul. 29, 2011

(51) Int. Cl. H04L 12/56

(52) U.S. Cl. 370/417

(57) ABSTRACT

Techniques are provided for sending response messages based on pending requests. A request message identifying a data packet may be received. A pending request structure may be used to determine output queues that are in need of the data packet identified in the request message. A response message may be sent indicating if the request message is being refused based on the output queues.

### BACKGROUND

Data networks are used to allow many types of electronic devices to communicate with each other. Typical devices can include computers, servers, mobile devices, game consoles, home entertainment equipment, and many other types of devices. These types of devices generally communicate by encapsulating data that is to be transmitted from one device to another into data packets. The data packets are then sent from a sending device to a receiving device. In all but the simplest of data networks, devices are generally not directly connected to one another.

Instead, networking devices, such as switches and routers, may directly connect to devices, as well as to other networking devices. A network device may receive a data packet from a device at an interface that may be referred to as a port. The network device may forward the data packet to another port for output to either the desired destination or to another network device for further forwarding toward the destination. The bandwidth available in a network device for such data transfer may be finite, and as such it would be desirable to make such transfers as efficient as possible.

### BRIEF DESCRIPTION OF THE DRAWINGS

FIG. 1 is a high level block diagram of an example of a network device.

FIG. 2 depicts an example of message content and structure that may be used in an embodiment.

FIG. 3 depicts an example of data structures that may be used to maintain the status of pending requests.

FIGS. 4(a-d) depict examples of sending data packets.

FIG. 5 depicts an example of a high level flow diagram for sending data packets.

FIGS. 6(a-b) depict an example of a high level flow diagram for receiving request messages and data packets.

### DETAILED DESCRIPTION

A network device may receive data packets from a plurality of sources and may route those data packets to the desired destination. In some cases the received data packets may be routed to multiple destinations. The network device may receive the data packets through ports that are connected to external packet sources. The network device may route those data packets to other ports on the network device through a switch fabric. The switch fabric allows for packets to be sent from one port on the network device to different ports. The network device may output the data packet on those different ports.

A set of ports may be grouped together in a node such that a data packet may be received by a port associated with a source node and be destined for a port associated with a destination node. Each port on the destination node may be associated with an output queue. Thus, a data packet may be received by a port on a source node, sent through the switch fabric to a destination node, and be placed in an output queue associated with the desired output port on the destination node.

In some cases, a data packet may be destined for multiple ports that are all associated with a single destination node. The data packet may be sent across the switch fabric individually for each desired port on the destination node. However, such an implementation is inefficient, as the same data packet may need to be sent across the switch fabric several times, once per desired output port on a destination node. Such duplicate transmission reduces the transport efficiency of the switch fabric due to redundant data packet transfers.

Furthermore, solutions which attempt a single transfer of a data packet are problematic as there is no way to guarantee that all of the output queues are able to receive a data packet at the time the data packet is sent. For example, a data packet may be destined for two output queues on a destination node. One queue may be full, and thus unable to receive the data packet. The destination node may have two options. First, the destination node may place the data packet in the output queue that is able to receive the data packet and maintain a local copy of the data packet. However, in this case, the destination node must not only locally store the data packet, but must also periodically examine the full output queue to determine when additional data packets may be added. As there may be many data packets within the networking device, the overhead of periodic examination may be substantial.

In the second option, the destination node may refuse the data packet, and request the source node send the data packet at a later time, when hopefully both output queues are able to receive the data packet. The second option is problematic, as there is no guarantee that there will ever be a time when both output queues are simultaneously able to receive the data packet. For example, by the time the full output queue is able to receive the data packet, the other queue may have become full. Thus, the networking device could become deadlocked, as no progress on transferring the data packet is possible.

Example embodiments described herein reduce the problem of duplicate data packet transfers by providing techniques for sending a data packet from a source node to a destination node the minimal number of times, while at the same time avoiding the problem of multiple output queues that cannot all simultaneously accept the data packet. The techniques described herein further allow for the destination node to maintain a status as to which output queues are in need of the data packet. The destination node need not periodically check the status of the output queues, but rather is prompted by the source node to check the status. In some implementations, the destination node may further reduce the number of data packet transfers by maintaining a local copy of the data packet.

The source node may send the destination node a request message identifying a data packet to be transferred. The destination node may determine if none, all, or some of the output queues associated with the desired output ports are able to receive the data packet. In the case where none of the output queues are able to receive the data packet, the destination node may notify the source node to send the request message again at a later time. In the case where all of the output queues are able to receive the data packet, the destination node may notify the source node that the request message need not be sent again. The data packet may be sent to the destination node and placed in the desired output queues.

If only some of the output queues are able to receive the data packet, the data packet may be sent to the destination node and placed in the output queues that are able to receive the data packet. The destination node may notify the source node to resend the request message at a later time. When the destination node receives the resend of the request message, the destination node may determine which of the remaining output queues still need the data packet and are able to receive it. The data packet may be sent to the destination node and placed in the output queues that are able to receive it. This process may continue until the data packet has been added to all the desired output queues.

In some example implementations, the destination node may attempt to store a local copy of the data packet, if sufficient resources are available, whenever it is determined that the data packet may be needed again. When a resent request message is received, the destination node may determine if a local copy of the data packet exists. If so, the local copy of the data packet may be added to the output queues that are able to receive the data packet, rather than resending the data packet from the source node to the destination node, thus further reducing the number of times a data packet may be sent over the switch fabric.

Thus, regardless of the number of output ports, or the ability of each of the output queues associated with the output ports to receive the data packet, the number of times the data packet is sent across the switch fabric may be minimized. Furthermore, an output queue that needs a data packet and is able to receive the data packet may not be blocked because a different output queue is not able to receive the data packet, thus ensuring that forward progress for each output queue is not dependent on other output queues.

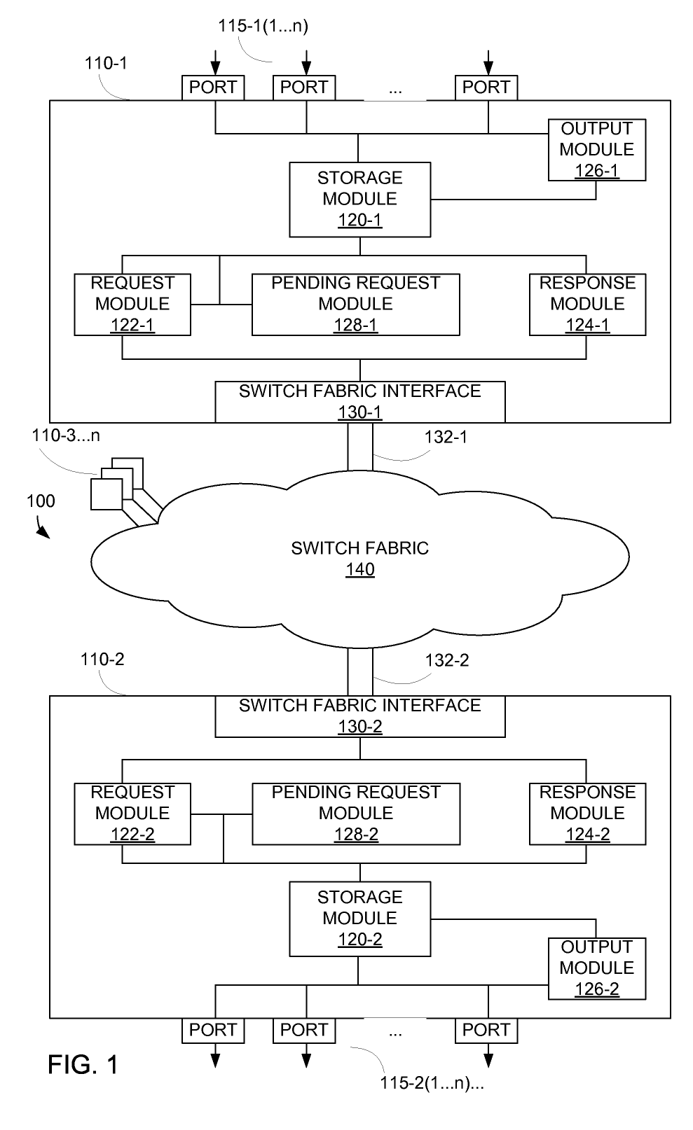

FIG. 1 is a high level block diagram of an example of a network device. The network device 100, such as a switch or router, may implement the example techniques described herein in order to provide for the ability to distribute a data packet to multiple output ports on a node. The network device may include a plurality of nodes 110-1 . . . n. For purposes of clarity, only two nodes 110-1,2 are shown in detail in FIG. 1, however it should be understood that there may be any number of nodes, all of which have a generally identical structure. Furthermore, all nodes are capable of both sending and receiving packets, and may be doing so simultaneously. However, for ease of description, FIG. 1 will be described in terms of a source node 110-1 which may receive data packets from external sources and send the data packets to destination node 110-2. The destination node may receive the data packet and output the data packet to one or more ports. It should be understood that in operation, a node may act as both a source node and a destination node at the same time for different data packets or even for the same packet.

Source node 110-1 may include a plurality of ports 115-1(1 . . . n). Ports 115-1 may be used to connect to external sources of data packets, such as computers, servers, or even other network devices. The source node 110-1 may receive data packets from these external sources through the ports. The number of ports that exist on a source node may be determined by the design of the network device. For example, in some modular switches, capacity may be added by inserting an additional line card containing 4, 8, 16, or 32 ports. The line card may also contain a node chip to control the data packets sent to and received from the ports. In some cases, depending on the number of ports included on a line card, more than one node chip may be required. However, for purposes of this explanation, a set of ports may be controlled by a single node chip.

The node chip, which may simply be referred to as a node, may typically be implemented in hardware. Due to the processing speed requirements needed in today's networking environment, the node may generally be implemented as an application specific integrated circuit (ASIC). The ASIC may contain memory, general purpose processors, and dedicated control logic. The various modules that are described below may be implemented using any combination of the memory, processors, and logic as needed.

The source node 110-1 may include a storage module 120-1, a request module 122-1, a response module 124-1, an output module 126-1, a pending request module 128-1, and a switch fabric interface 130-1. Data packets may be received from the ports 115-1. These data packets should be output from one or more ports of the destination node. There is no requirement as to how the data packets are transferred within the network device. The received data packets may be stored in the storage module 120-1. Storage module 120-1 may be any form of suitable memory, such as static or dynamic random access memory (SRAM/DRAM), FLASH memory, or any other memory that is able to store data packets.

The request module 122-1 may be notified of data packets as they are added to the storage module. In some example implementations, the request module may determine to which nodes and which ports on those nodes a data packet should be sent. In other example implementations, the source node may determine to which destination nodes a data packet should be sent and may include information used to determine the correct output ports. The destination node may use this information to determine which ports of the destination node should receive the data packet. For simplicity of explanation, the examples contained herein describe a data packet that may be sent to multiple ports of a single destination node. However, it should be understood that the techniques described herein are also applicable to a data packet that is to be sent to multiple ports of multiple destination nodes. In cases where there are multiple destination nodes, the techniques described herein may be applied generally to each pairing of source node and destination nodes independently. The application of the techniques may occur in parallel between each pairing of the source node and destination nodes.

The request module may generate and send request messages to the determined destination node to inform the destination node that a data packet is available for delivery. The request module may send the request messages to the determined destination node through a switch fabric interface 130-1. The switch fabric interface 130-1 is the interface through which a node communicates with the switch fabric 140. The switch fabric interface may contain a communications link 132-1. Although depicted as a single link, it should be understood that there may also be multiple physical links to the switch fabric. The destination node 110-2 may also contain a switch fabric interface and associated communications link. The combination of a communications link on the source node, a path through the switch fabric 140, and a communications link on a destination node may form a communications channel. The source and destination nodes may communicate by sending messages over the communications channel.

The switch fabric 140 is used to connect the nodes 110-1 . . . n. The switch fabric may receive messages from a source node 110-1 through the switch fabric interface 130-1 and may route those messages to the destination node 110-2. The destination node may receive the messages through its own switch fabric interface 130-2. The same applies for communication in the reverse direction.

The destination node 110-2 may have a similar structure to the source node 110-1, however the various modules may provide different processing when acting as a destination node. The same modules shown on node 110-1 may also be present on destination node 110-2. The request message may be received by the request module 122-2 on the destination node. The request module may identify the output ports 115-2(1 . . . n) that are the intended recipients of the data packet. In order to output a data packet on a port, the data packet may be added to an output queue associated with the port. The destination node may use the output module 126-2 to determine the status of output queues associated with the identified ports. The status may include the ability of the output queue to receive a data packet. For example, the output queue may be of finite length, and thus can store a finite number of data packets. If an output queue is full, no additional data packets may be received.

The destination node 110-2 may determine if none, all, or some of the identified ports are able to receive the data packet. If none of the identified ports are able to receive the data packet, there may be no need for the data packet to be transferred from the source node 110-1 to the destination node at this time, as the data packet cannot be added to any output queue. The destination node may inform the source node to send the request message again at a later time. If all of the identified output ports are able to receive the data packet, the destination node may inform the source node that the data packet can be accepted, and the request message need not be sent again. In some example implementations, the destination node may initiate the transfer of the data packet from the source node to the destination node across the switch fabric 140. In other example implementations, the source node may initiate the transfer of the data packet to the destination node. The example implementations described herein describe the destination node initiating the transfer of the data packet, however it should be understood that in alternate implementations, the transfer of the data packet is initiated by the source node.

If only some of the identified ports are able to receive the data packet, the destination node 110-2 may use the pending request module 128-2 to attempt to allocate a pending request data structure. The pending request data structure may be used to keep track of which output queues need the data packet but have not yet received the data packet. The destination node may inform the source node 110-1 that the data packet cannot be accepted by all the identified ports at this time, such that the request message may need to be sent again at a later time. The destination node may also request that the data packet be sent from the source node to the destination node across the switch fabric 140. The data packet may be added to the output queues that are able to receive the data packet. In some example implementations, the data packet may also be stored in the storage module 120-2 of the destination node. When the request message is resent by the source node, there may be no need to resend the data packet, as it may already be stored on the destination node.

The destination node 110-2 may use the response module 124-2 to send a response message to the source node 110-1. The response message may indicate if the request message is being accepted by the destination node such that the request message need not be resent. Likewise the response message may indicate that the request message is being refused, such that the source node is informed that the request message may need to be sent again. The response message may also inform the source node if the data packet associated with the request message needs to be transferred to the destination node.

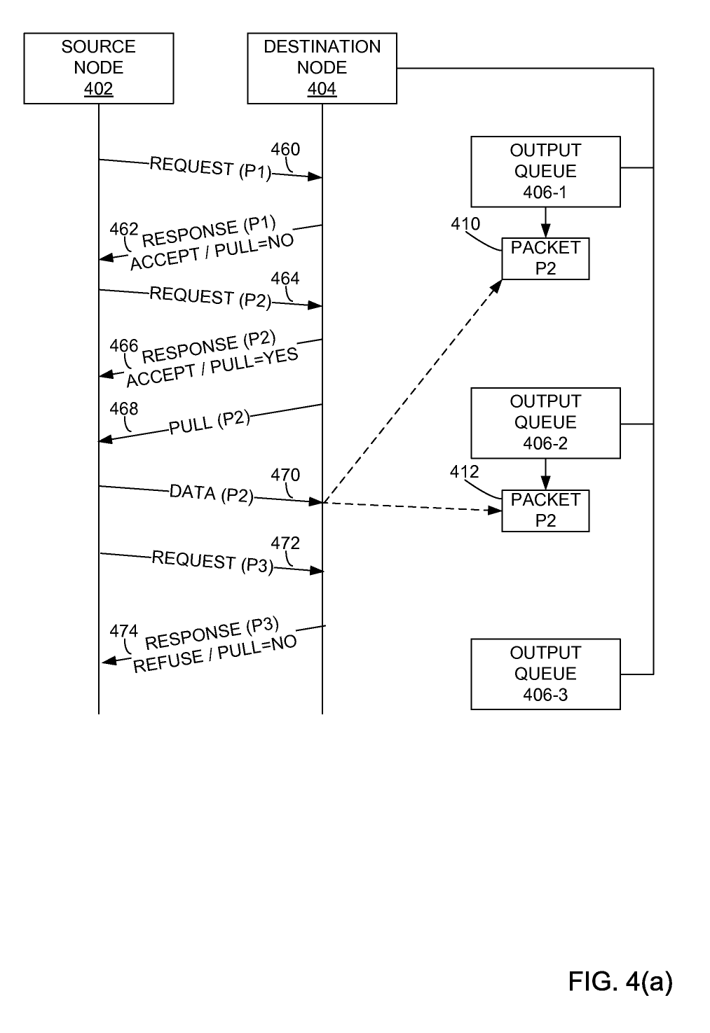

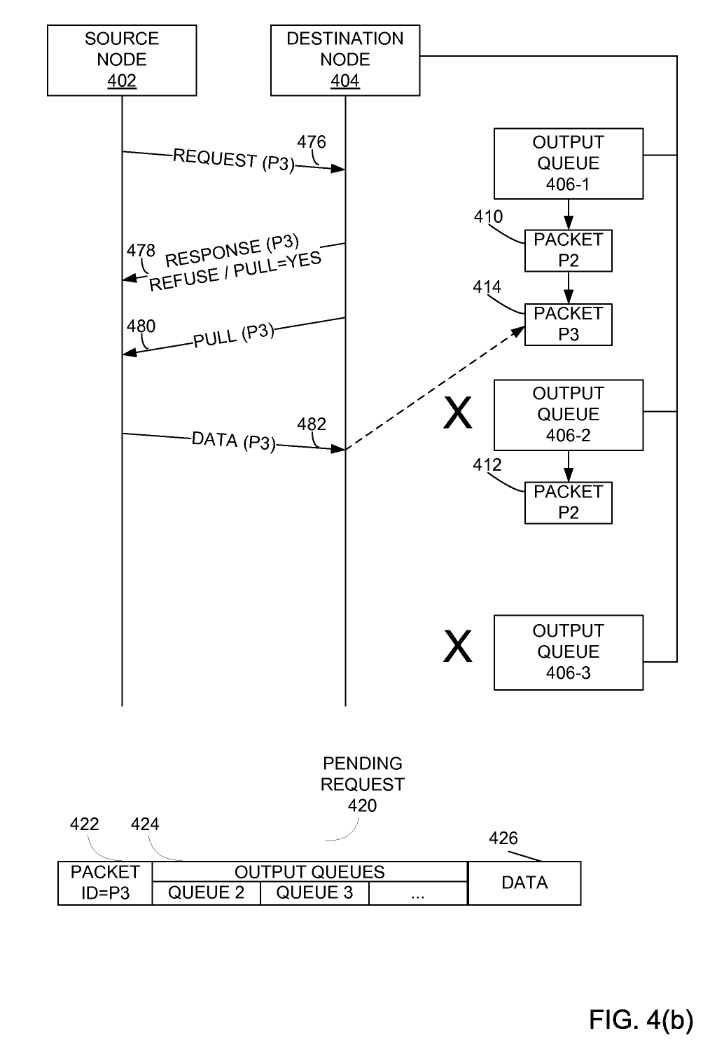

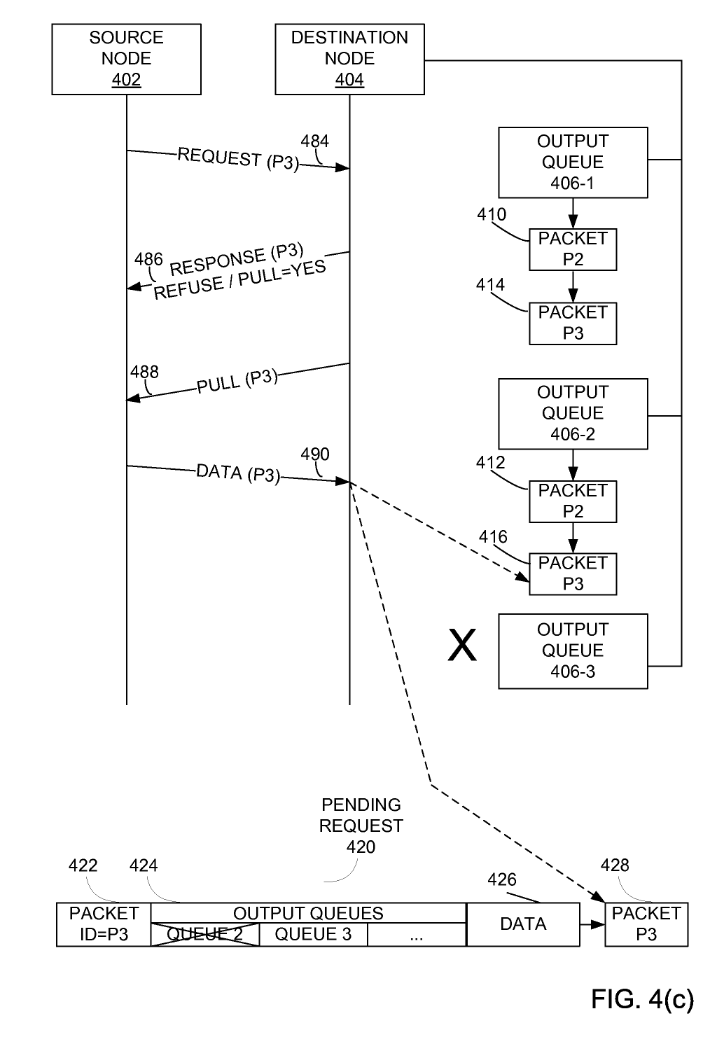

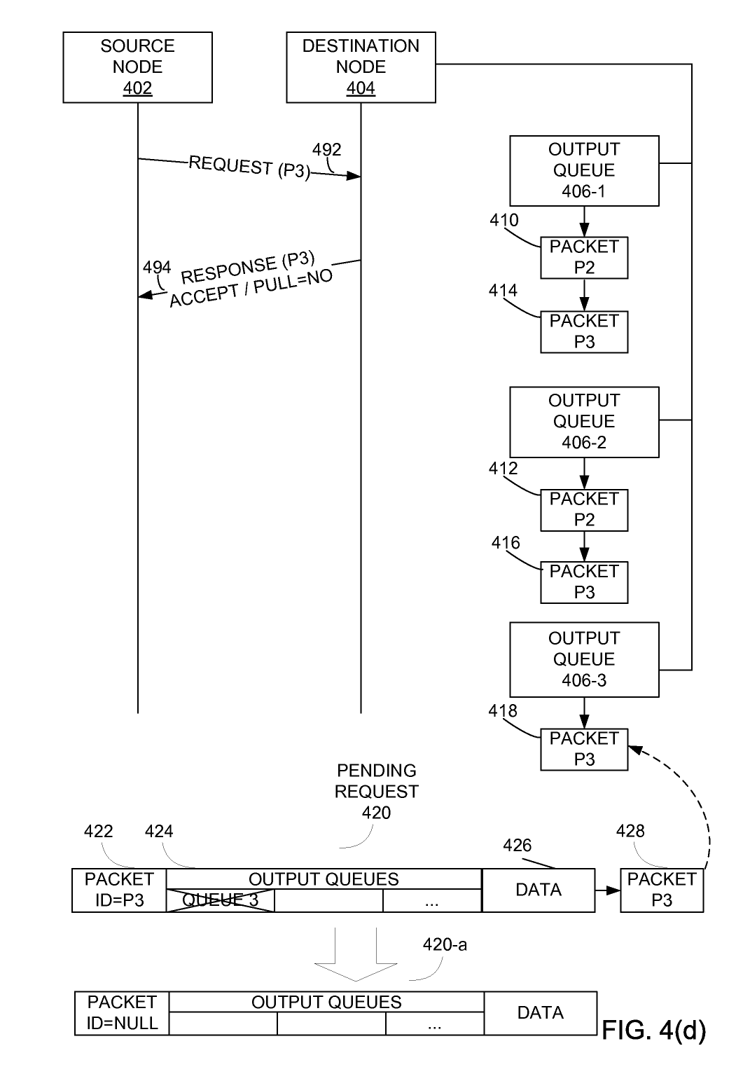

The response module 124-1 on the source node may receive the response message. If the response indicates the request message is accepted, the request module 122-1 may be notified that the request message does not need to be resent. Likewise, a refusal may notify the request module that the request message does need to be resent at a later time. Operation of the system described in FIG. 1 will be described in further detail with respect to FIGS. 4(a-d).

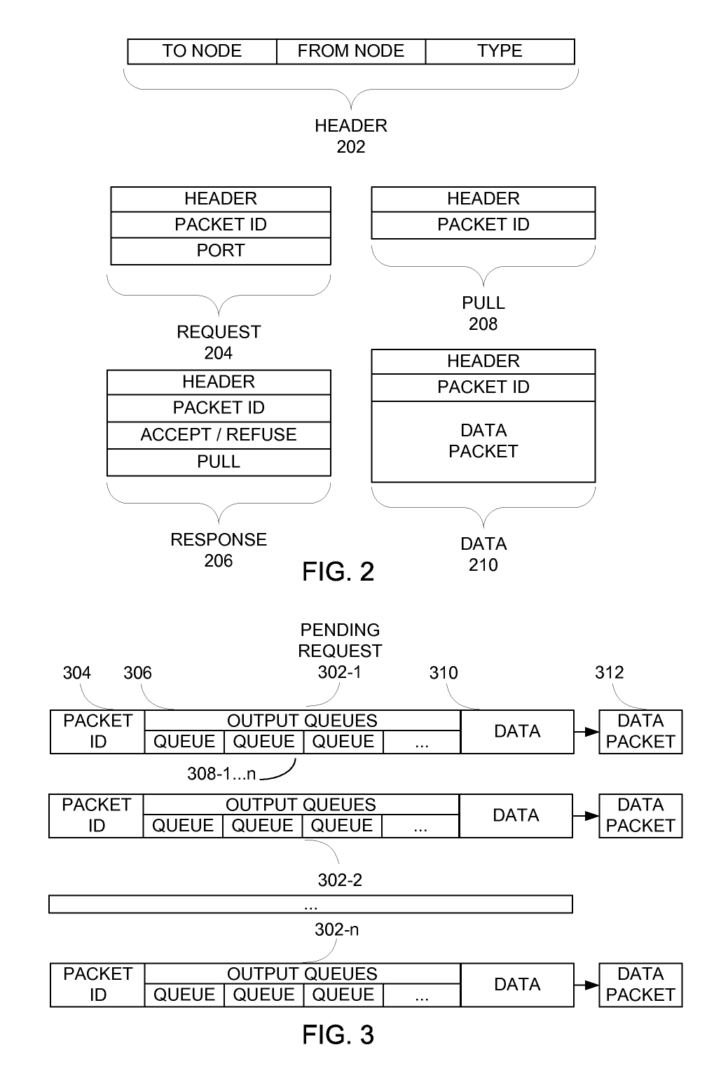

FIG. 2 depicts an example of message content and structure that may be used in an embodiment. The messages described in FIG. 2 are an example of those that may be used with the system as described in FIG. 1. In this example implementation, each message includes a header 202. The header may include a ‘To Node’ field which identifies the node that the message is intended for. Also included is a ‘From Node’ field which identifies the node that sent the message. The node identifications may used by the switching fabric to properly transfer messages from the sending node to the intended recipient node. In addition, the header may also include a ‘Type’ field which is further used to identify the contents and structure of the message when received.

In the present example implementation there are four message types. Each message type includes the header 202 which will not be described further. The first message type is the request message 204. The request message may be used by a source node to notify a destination node that a data packet is available for delivery. The request message includes a ‘Packet ID’ field. The ‘Packet ID’ field may be used to identify an individual data packet. For example, in one implementation, as each data packet is received at a source node, the data packet may be assigned an identifier. In another example implementation, the ‘Packet ID’ may indicate the location in memory where information related to the data packet is stored. Regardless of implementation, the ‘Packet ID’ field may be used by the source and destination node to identify the data packet that is referred to in the request message.

Also included in the request message may be a ‘Port’ field. The ‘Port’ field may be used to indicate on which ports of the destination node the data packet should be output. In some cases, the data packet may only be destined for output on a single port at a destination node and this port may be indicated in the ‘Port’ field. In other cases, the data packet may be destined for multiple ports on a destination node and each of those ports may be indicated in the ‘Port’ field. The destination node may maintain an output queue for each port and the ‘Port’ field may be used by the destination node to determine to which output queues the data packet should be added. In a different example implementation, the ‘Port’ field does not directly identify the output ports, but rather includes information that may be used by the destination node to determine to which output ports the data packet should be added.

The next message type is the response message 206. The response message may be used by a destination node to notify the source node that a request message has been received. The response message may include a ‘Packet ID’ field that identifies the data packet as described with respect to the request message. When the source node receives the response message, the ‘Packet ID’ field may be used to match the response message with the originally sent request message. The response message may also include an ‘Accept/Refuse’ field. The ‘Accept/Refuse’ field may be used by the destination node to inform the source node if the request message associated with a ‘Packet ID’ is being accepted or refused.

For example, if the destination node receives a request message and is able to fully process the request message, the destination node may return a response message indicating that the request message was accepted. A response indicating acceptance of a request message notifies the source node that the request message need not be sent again. Likewise, if the destination node is unable to fully process the request message, a response message indicating a refusal may be sent to the source node. For example, if the data packet cannot be added to an output queue because the output queue is full, a response message indicating refusal may be sent. A response message indicating a refusal may notify the source node that the request message may need to be resent at a later time.

The response message may also include a ‘Pull’ field. The ‘Pull’ field may be used by the destination node to notify the source node that the data packet should be transferred from the source node to the destination node. The ‘Pull’ field may be a yes/no field, wherein a yes indicates that the data packet should be transferred to the destination node, whereas a no indicates the data packet does not need to be transferred. It should be understood that the ‘Pull’ field itself does not cause the data packet to be transferred. As described further below, in some example implementations, the destination node may send another message to initiate the transfer of the data packet, while in other example implementations, the source node itself initiates transfer of the data packet. In some cases, a request message may be sent for a data packet, but the destination node has no need for the data packet to be sent from the source node. For example, the computer for which the data packet is destined may no longer be available and as such there would be no reason for the source node to send the data packet as it may never reach its intended destination.

The ‘Pull’ field may be used to notify the source node if the data packet associated with the response message should be transferred from the source to the destination node. If no output queue on the destination node is in need of the data packet, or the destination node already has a local copy of the data packet, the ‘Pull’ field may indicate the data packet does not need to be sent from the source to the destination node. If at least one output queue on the destination node is in need of the data packet, at least one response message may include a ‘Pull’ field set to yes. Depending on the ability of the destination node to store a local copy of the data packet, more than one response message may have the ‘Pull’ field set to yes.

The ‘Accept/Refuse’ field in combination with the ‘Pull’ field may be used by the source node to determine when a data packet may be discarded at the source node. For example, once a request message is accepted, the source node is notified that no further request messages may be needed for the data packet associated with the request message. Because no further request messages may be sent for the data packet, no further response messages, including response messages with a ‘Pull’ field set to yes, may be received for the data packet. The total number of response messages received with the ‘Pull’ field set to yes may indicate the number of times the data packet is to be transferred from the source to the destination node. Once the data packet has been transferred the number of times determined by response messages with the ‘Pull’ field set to yes, the source node is aware that no additional transfers of the data packet may be needed. Thus, the source node may discard the data packet, as the data packet has been transferred the number of times indicated by the total number of response messages with a ‘Pull’ field set to yes and no additional response messages are expected because no additional request messages may be sent. Use of the request and response messages will be described in further detail with respect to FIGS. 4(a-d).

The preceding description of discarding a data packet at a source node was in terms of a single source and destination node. However, as mentioned above, a data packet may be destined for multiple ports on multiple destination nodes. In such a case, the data packet may not be discarded until responses indicating acceptance have been received from all destination nodes that are to receive the data packet and the data packet has been transferred to each destination node the desired number of times.

The next message type is the pull message 208. The pull message may be used by the destination node to initiate retrieval of the data packet from the source node in implementations in which the destination node initiates the transfer. The pull message may include a ‘Packet ID’ field which is used to identify the data packet that is being retrieved. The pull message may instruct the source node to send the data packet identified by the ‘Packet ID’ field to the destination node. The data packet may be sent to the destination node in the last message type, which is the Data message 210. The data message may include a ‘Packet ID’ field which is used to identify the data packet, as was described above. The data message may also include a ‘Data Packet’ field, which is where the actual content of the data packet is stored for transport from the source to the destination node. An example implementation that uses the message type described above will be described in further detail with respect to FIGS. 4(a-d). In implementations where the data packet transfer is initiated by the source node, there may not be a pull message.

FIG. 3 depicts an example of data structures that may be used to maintain the status of pending requests. A pending request data structure may be used when a data packet is destined for multiple output queues on a destination node, but not all of the output queues are currently able to add the data packet to the queue. Pending request data structure 302-1 may contain several fields. A packet ID field 304 may be used to identify the data packet associated with the pending request data structure. The packet ID may be the same ID that was described above with respect to FIG. 2. The packet ID may be used to correlate request messages with pending request data structures. For example, when a request message is received, the packet ID contained therein may be compared to the packet ID stored in the pending request data structures to determine if a pending request data structure already exists for the data packet.

Pending request data structure 302-1 may also contain an output queues field 306. The output queues field may be used to identify output queues that may be in need of the data packet identified by the packet ID, but cannot currently add the data packet to the queue. The output queues field may contain queue indicators 308-1 . . . n. The queue indicators may indicate which particular output queues are in need of the data packet. In one example implementation, the queue indicators are a bit field, with each bit representing an output queue on the destination node. A set bit may indicate an output queue that is in need of the data packet while a clear bit indicates the output queue does not need the data packet. In a different example implementation, the queue indicators may be a list of output queues that are in need of the data packet associated with the pending request data structure.

Pending request data structure 302-1 may also contain a data field 310. In some example implementations, the destination node may attempt to maintain a local copy of the data packet, if sufficient resources are available. In such implementations, if a local copy of the data packet exists, data field 310 may identify the location in memory where the local copy of the data packet 312 is stored. If the data field 310 is empty, this may indicate that no local copy of the data packet exists on the destination node.

The destination node may maintain a finite number of pending request data structures 302-1 . . . n, thus a pending request data structure may not always be available when needed. When a request message is received, the destination node may need to quickly determine if a pending request data structure already exists for the request message or if a pending request data structure is available to be allocated for the request message. In some example implementations, a hash table may be used to quickly locate a pending request data structure. Each pending request data structure may be associated with an entry in the hash table. When a request message is received, the packet ID may be input to a hash function to determine the appropriate entry in the hash table. It should be understood that the hash function may map many different packet IDs to the same hash table entry. The pending request data structure associated with the entry in the hash table may be examined to determine if the packet ID field is the same as the packet ID in the request message. If there is a match, the pending request data structure for the associated data packet already exists. If there is a packet ID stored, but it does not match the packet ID in the request message, the pending request structure may already be in use, and thus cannot be allocated. If the packet ID field is empty, the pending request data structure is available to be allocated for the request message.

Although a hash table has been described, any other mechanism of determining if a pending request data structure exists or is available may also be used. In a different example implementation, the pending request data structures may be arranged in a linked list. The destination node may traverse the list to determine if any of the pending request data structures have a packet ID that matches the packet ID in the request message. If not, the list may be traversed until a pending request data structure is found that does not have a packet stored in the packet ID field, thus indicating the structure is available for use. Regardless of how implemented, the destination node has the ability to determine if a pending request data structure exists or is able to be allocated for a data packet. Use of the pending request data structure will be described in further detail with respect to FIGS. 4(a-d).

FIGS. 4(a-d) depict examples of sending data packets. Source node 402 may have a plurality of data packets, which will be identified as data packets P1, P2, and P3, that may be sent to a destination node 404. The destination node may have output queues 406-1,2,3. Each of the data packets P1, P2, and P3 may be destined for zero, one, or more than one output queue. For ease of description, as each data packet is introduced, the intended output queues will be identified. It should be understood that the determination of output queues may be made by the source node or the destination node, depending on the implementation. However, operation of the system is not dependent on which node determines which output queues are to receive the data packet.

Source node 402 may have data packet P1 that is destined for output queue 406-1. The source node may send a request message 460 to the destination node 404 indicating a packet ID of P1. The destination node may receive the request message and determine that output queue 406-1 does not have a need for the data packet. For example, output queue 406-1 may be associated with a port that is connected to a computer and that computer may not be available. Thus, there would be no need for the data packet to be sent to the destination node as it could never be delivered to the computer.

Destination node 404 may send a response message 462 to the source node 402. Included in the response message may be an indication that the destination node has accepted the request message. The acceptance indication informs the source node that the request message does not need to be resent. The response message may also include a pull field set to no. The pull field may notify the source node that the data packet may not be sent to the destination node. If the data packet is only being sent to a single destination node, the source node may discard the data packet. The source node may discard the data packet because the source node does not need to send the request message again and the data packet may not be sent to the destination node. As such, the data packet is no longer needed. It should be understood that if more than one destination node is to receive the data packet, the data packet may not be discarded until all destination nodes that are to receive the data packet have indicated that both the request message need not be resent and that no further transfers of the data packet from the source to the destination nodes are needed.

Source node 402 may also have data packet P2 that is destined for output queues 406-1,2. The source node may send request message 464 to the destination node 404 indicating a packet ID of P2. For ease of description, assume that request message 464 is the first request message for data packet P2 and as such the destination node may not find a pending request data structure for data packet P2. Use of the pending request data structure will be described in further detail below. The destination node may receive the request message and determine that output queues 406-1,2 are both able to accept data packet P2. The destination node may send a response message 466 to the source node. Included in the response message may be an indication that the destination node has accepted the request message. As above, the acceptance informs the source node that the request message does not need to be resent. The response message may also include a pull field set to yes, which notifies the source node that the data packet P2 shall be transferred to the destination node. It should be noted that the source node does not discard data packet P2 because although an acceptance has been received, the data packet has not yet been transferred.

The destination node 404 may send a pull message 468 identifying data packet P2. The pull message notifies the source node 402 that data packet P2 is being requested by the destination node and should be sent in a data message. As mentioned above, in alternate example implementations, the source node may initiate the transfer of the data packet rather than sending the data packet in response to a pull message. The source node may send data packet P2 in a data message 470. At this point, assuming the data packet is being sent to a single destination, the source node may discard data packet P2 as both an acceptance has been received and the data packet has been sent the same number of times as response messages with the pull field set to yes have been received. Upon receipt of the data message, the destination node may add data packet P2 to the output queues 406-1,2. As shown, data packets 410, 412 which contain the contents of data packet P2 are added to the output queues. Because data packet P2 was not destined for output queue 406-3, the data packet is not added to that output queue.

Source node 402 may also have data packet P3 that is destined for output queues 406-1,2,3. The source node may send request message 472 to the destination node 404 indicating a packet ID of P3. Again, assume that no pending request data structure has been associated with data packet P3. The destination node may receive the request message and determine that none of output queues 406-1,2,3 are able to accept data packet P3. Alternatively, the destination node itself may not be able to receive the data packet due to resource limitations. For example, the destination node may be in an overloaded state and is unable to process the request message.

Regardless of the reason why the destination node is not willing to receive the data packet P3, it would be inefficient to send data packet P3 to the destination because the data packet would not be placed in any output queue. The destination node may send a response message 474 including an indication of refusal of the request message. The refusal indication notifies the source node that the request message may need to be sent again at a later time. The response message may also include a pull field set to no, indicating that the data packet may not be pulled at this time. As mentioned above, the data packet cannot be added to any output queue and transferring the data packet would unnecessarily use resources such as switch fabric bandwidth.

FIG. 4(b) is a continuation of FIG. 4(a). At some point later in time, the source node 402 may resend the request message for data packet P3. In some example implementations, the source node may resend the request as soon as the response message 474 indicating refusal is received. In other example implementations, the source node may delay for a period of time before resending the request message. The delay may be useful for allowing time for the destination node to clear the condition that caused the original refusal. For example, if the refusal was due to the output queues being full, a delay may allow for data packets in the output queues to be output, thus creating empty space in the output queues.

The source node 402 may send request message 476 which identifies data packet P3. Request message 476 is a resend of request message 474. The destination node may receive the request message and determine if a pending request data structure associated with data packet P3 exists. As no such structure exists because data packet P3 has not yet been received, the destination node may determine if any of the output queues 406-1,2,3 are able to receive the data packet P3. In the present example, assume only output queue 406-1 is able to receive the data packet at this time. Because all of the desired output queues are not able to receive the data packet at this time, but at least one output queue is able to receive the data packet, the destination node may attempt to allocate a pending request data structure. The destination node may use the hash table or other mechanism to determine if there is a pending request data structure that is not currently in use and can be allocated for the data packet associated with the request message.

The destination node 404 may find an available pending request data structure 420. The destination node may store the packet ID of the data packet in the packet ID field of the pending request data structure. As shown, packet ID P3 is stored in the packet ID field 422 of the pending request data structure. The destination node may also store an indication of the output queues that need the data packet, but are currently not able to receive the data packet. As such, output queues 2 and 3 may be stored in the output queues field 424, as those queues need data packet P3 but are unable to receive the data packet at this time.

The destination node 404 may send a response message 478 to the source node 402. The response message may include an indication that the request message is being refused. As above, the refusal indication may notify the source node that the request message may need to be resent. The response message may also include a pull field set to yes. Setting the pull field to yes may notify the source node that the data packet P3 should be transferred from the source node to the destination node. The destination node may send a pull message 480 identifying data packet P3. In response to the pull message, the source node may send data packet P3 in a data message 482.

Upon receipt of the data message 482, the destination node 404 may add the data packet to the output queues that are able to receive the data packet. As shown, the data packet 414 may be added to output queue 406-1, which was determined to be able to receive the data packet. The destination node may also attempt to store a local copy of the data packet 414 for later use if there is at least one output queue that needs the data packet but is currently unable to receive it and sufficient resources, such as memory, exist on the destination node to store the local copy. For purposes of this description, assume that no local copy of the data packet is stored at this time. Storing a local copy of the data packet will be described in further detail below.

FIG. 4(c) is a continuation of FIG. 4(b). At some point later in time, the source node 402 may resend the request message 484 for data packet P3. As mentioned above, there may be a delay introduced by the source node prior to resending the request message. The destination node 404 may receive the request message and determine if a pending request data structure associated with data packet P3 exists. As mentioned above, the destination node may use a hash table to identify a pending request data structure and determine if that structure has a packet ID field set to P3. The destination node may identify pending request data structure 420 as being associated with data packet P3.

The destination node 404 may examine the output queues field 424 of pending request data structure 420 to determine which output queues are in need of the data packet, and of those output queues, which ones are able to receive the data packet. Output queues 2 and 3 were in need of the data packet prior to receipt of request message 484. As shown, output queue 2 may now be able to receive the data packet, while output queue 3 is still unable to receive the data packet. The destination node may examine the data field 426 of the pending request data structure to determine if a local copy of the data packet exists. As explained above, at this point in the description, no local copy of the data packet exists on the destination node.

The destination node may send a response message 486 to the source node. The response message may indicate that the request message may need to be resent, as output queue 3 is still unable to receive the data packet. The response message may also include a pull field set to yes to indicate that the data packet should be transferred from the source node to the destination node. The destination node may send a pull message 488 identifying data packet P3. In response, the source node may send data packet P3 to the destination node in a data message 490. The destination node may add the data packet 416 to output queue 406-2. The destination node may also remove output queue 2 from the output queues field 424 of the pending request data structure, as output queue 2 no longer needs data packet P3, as it has already been added to that queue.

In addition, the destination node may determine if it would be beneficial to store a local copy of the data packet. If at least one output queue still needs the data packet, storing a local copy of the data packet may reduce the number of transfers of the data packet across the switch fabric. In the present example, output queue 3 still needs the data packet, thus it may be beneficial to store a local copy of the data packet. The destination node may determine if sufficient resources exist to maintain the local copy of the data packet. For example, the destination node may determine if sufficient memory is available to store the local copy of the data packet. If sufficient resources are available, the destination node may store a local copy of the data packet 428. The data field 426 of the pending request data structure may be updated to identify the location in memory where the local copy of the data packet 428 is stored.

FIG. 4(d) is a continuation of FIG. 4(c). At some point later in time, the source node 402 may resend the request message 492 for data packet P3. As mentioned above, there may be a delay introduced by the source node prior to resending the request message. The destination node 404 may receive the request message and determine if a pending request data structure associated with data packet P3 exists, as has been described above. The destination node may identify pending request data structure 420 as being associated with data packet P3.

The destination node 404 may examine the output queues field 424 of pending request data structure 420 to determine which output queues are in need of the data packet, and of those output queues, which ones are able to receive the data packet. As shown, output queue 3 is in need of the data packet. As shown, output queue 3 may now be able to receive the data packet. The destination node may examine the data field 426 of the pending request data structure to determine if a local copy of the data packet exists. As shown, the data field points to a portion of memory that stores a local copy 428 of the data packet P3. The destination node may add data packet 418 which contains the content of data packet P3 to output queue 406-3. Data packet P3 may be retrieved from the location pointed to by data pointer 426. The data packet need not be pulled from the source node 402, thus eliminating a duplicate transfer of data packet P3 across the switch fabric. The destination node may remove output queue 3 from the output queues field of the pending request data structure 420. As shown, no output queues remain in the pending request data structure.

The destination node 404 may release the pending request data structure 420. The packet ID field 422 may be cleared, as well as the data field 426. The memory space allocated for data packet P3 may also be released. Pending request data structure 420-a depicts the pending request data structure 420 after the structure has been released. The pending request data structure is made available for allocation for a new data packet. The destination node may send a response message 494 to the source node 402. The response may include an indication that the request message was accepted. As such, the source is informed that the request message for data packet P3 no longer needs to be resent. Furthermore, as the data packet has already been transferred the same number of times as response messages with the pull field set to yes, there is no longer a need for the source node to transfer data packet P3 to the destination node. As such, data packet P3 may be discarded by the source node if the data packet is not being sent to any other destination nodes.

In the preceding example, the destination node was able to allocate a pending request data structure for use in relation to the transfer of data packet P3. However, in some situations, the destination node may not be able to allocate a pending request data structure. For example, all structures may be in use handling transfers of other data packets. In such cases, the destination node may issue a response message indicating a refusal of the request message with the pull field set to no, just as was done with the first request message 472 for data packet P3. The reason for this is that without the pending request data structure, the destination node would not be able to track which output queues have already received the data packet. The source node would resend the request message as described above.

Furthermore, as described with reference to FIG. 4(c,d), the destination node may attempt to store a local copy of the data packet, if sufficient resources are available. However, in some example implementations, if resources become scarce on the destination node, the resources used to store the local copy of the data packet may be released. For example, if at some point memory resources on the destination node become scarce, the destination node may discard the local copy of the data packet, such that the memory used is freed for other purposes. The local copy of the data packet may be discarded at any time, thus the presence of the local copy of the data packet is determined at the time the data packet is needed. If the local copy does not exist, even if it had existed in the past, at the time the destination node is in need of the data packet, the data packet may need to be resent from the source node.

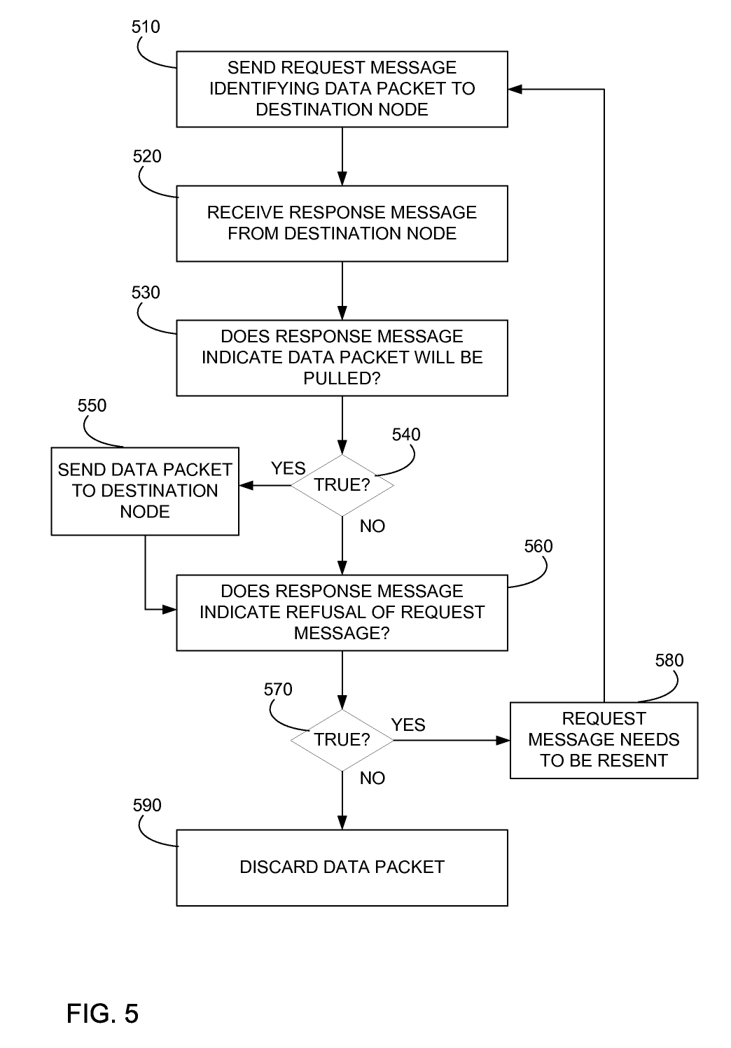

FIG. 5 depicts an example of a high level flow diagram for sending data packets. In block 510 a request message which identifies a data packet may be sent from a source node to a destination node. The request message may be used to notify the destination node that a data packet is available for delivery. In block 520 a response message may be received. The response message may be the destination node's response to the request message. In block 530 the response message is examined to determine if the response message indicates that the data packet may be pulled by the destination node. If the response message indicates that the data packet may be pulled, this means that the destination node desires the data packet and may request that the data packet be sent from the source to the destination node.

In block 540, the result of block 530 is evaluated. If the response does indicate that the data packet may be pulled by the destination node, the process moves to block 550. In block 550, the data packet may be sent to the destination node. In some example implementations, the destination node requests the data packet, while in other example implementations, the source node initiates the transfer of the data packet. Regardless of the result of block 540, the process moves to block 560.

In block 560 it may be determined if the response message indicates refusal of the request message. A refusal of the request message means that the destination node is unable to fully process the request message at this time. The request message may need to be resent at a later time. In block 570, the result of block 560 is evaluated. If the response message does indicate the refusal of the request message, the process moves to block 580. In block 580, it is determined that the request message needs to be resent. In some example implementations, the source node may introduce a delay before resending the request message in block 580. The process may move to block 510 wherein the request message is sent again.

If the response message does not indicate refusal of the request message, the process moves to block 590. In block 590, the data packet may be discarded by the source node. The reason for discarding the data packet is that it is no longer needed. The data packet has already been sent to the destination node in block 550 if it was needed. The arrival at block 590 indicates that the destination node has accepted the request message so the request message does not need to be resent. As such, there is nothing further to do with respect to sending the data packet from the source node to the destination node and the data packet may be discarded at the source node.

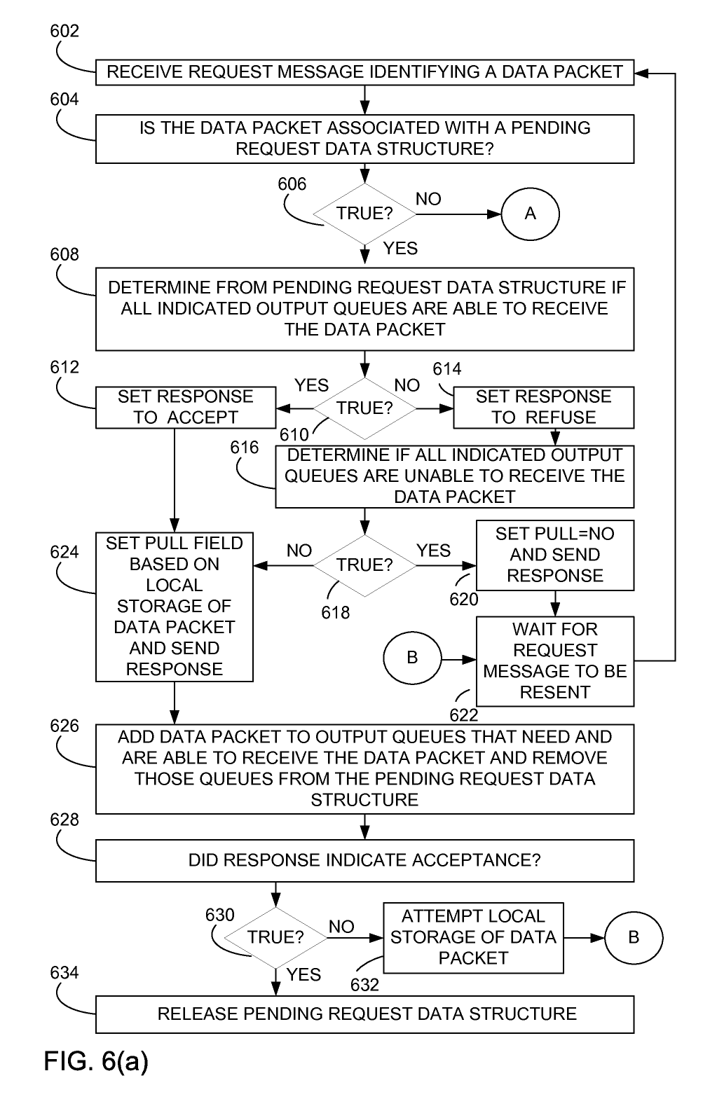

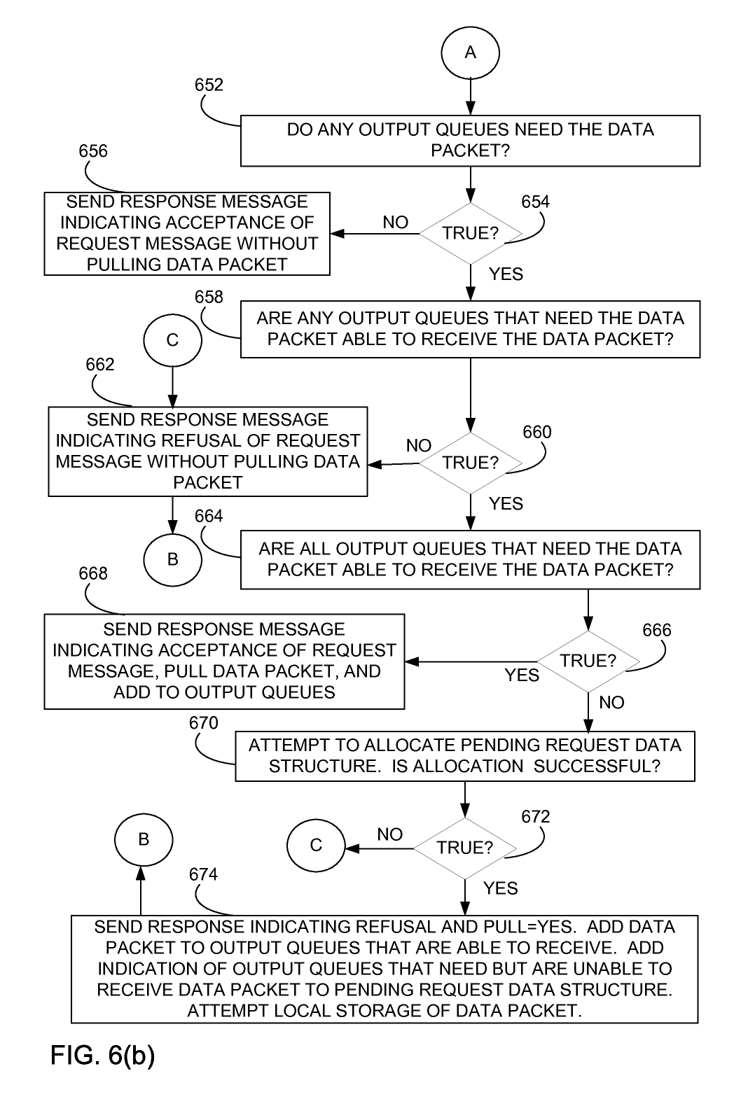

FIGS. 6(a-b) depict an example of a high level flow diagram for receiving request messages and data packets. In block 602 a request message that identifies a data packet may be received. The request message may be sent from a source node and received at a destination node. In block 604 the destination node may determine if the data packet is associated with a pending request data structure. In block 606, if the data packet is not associated with a pending request data structure, the process moves to reference A, which will be described below. If the data packet is associated with a pending request data structure, the process moves to block 608.

In block 608 it may be determined, from the pending request data structure, if all output queues indicated as needing the data packet are able to receive the data packet. In other words, it may be determined if the data packet can be added to all of the output queues that need the data packet. In block 610 if the result of the determination in block 608 is true, the process moves to block 612. In block 612 the accept/refuse field of a response message may be set to accept. When the response message is later sent to the source node, the source node may be notified that the request message need not be resent. Otherwise, the process moves to block 614 and the accept/refuse field is set to refuse, such that the source node is informed that the request message may need to be resent.

In block 616 it may be determined if all output queues indicated as needing the data packet are unable to receive the data packet. In other words, it may be determined if the data packet can be added to at least one output queue. In block 618, if the result of the determination is true, meaning that the data packet cannot be added to any output queues, the process moves to block 620. In block 620 the pull field of the response message may be set to no, indicating that the data packet need not be sent from the source node to the destination node. The response message may be sent to the source node. In block 622 the destination node may wait for the request message to be resent from the source node. When the request message is resent, the process begins again at block 602.

If the determination in block 618 is not true, it means that the data packet can be added to at least one output queue. In block 624, the pull field of the response message may be set based on local storage of the data packet. If a copy of the data packet is locally stored on the destination node, the pull field may be set to no, whereas if no local copy exists, the pull field may be set to yes. The response message may be sent to the source node. If the pull field is set to yes, the data packet may be transferred from the source to the destination node.

In block 626 the data packet may be added to the output queues that need and are able to receive the data packet. The data packet may be added from the copy that was locally stored, if one exists or from the data packet that was sent from the source node. The output queues that were able to receive the data packet may be removed from the pending request data structure. In block 628, it may be determined if the response message indicated acceptance of the request message. In other words, in block 628 it may be determined if the response message was set to accept in block 614. In block 630, if the result of the determination in block 628 is true, the process moves to block 634. In block 634, the pending request data structure may be released. The reason the pending request data structure may be released is that a response indicating acceptance means that the data packet was able to be added to all output queues that need the data packet. As such, there is no longer a need to maintain status of output queues that are unable to receive the data packet, as no such queues could exist.

If it is determined in block 630 that the response did not indicate acceptance, the process moves to block 632. In block 632 an attempt to store a local copy of the data packet may be made if a local copy of the data packet does not already exist. The reason for this is because if the response did not indicate acceptance of the request message, at least one output queue still needs, but is unable to receive the data packet. Storing a local copy of the data packet may eliminate a transfer of the data packet from the source node to the destination node. Regardless of the ability of the destination node to store a local copy of the data packet, the process moves to reference B, which was described above.

If it is determined in block 606 that the data packet is not associated with a pending request data structure, the process moves to reference A, which is shown in FIG. 6(b). In block 652 it may be determined if any of the output queues on the destination node need the data packet. In block 654, if it is determined that none of the output queues need the data packet, the process moves to block 656. In block 656 a response message may be sent to the source node. The response message may indicate acceptance of the request message without pulling the data packet. As described above, the acceptance may notify the source node that the request message does not need to be resent. Because the data packet may not be pulled, the source node may discard the data packet, if the data packet is not being sent to any other destination nodes.

If it is determined in block 654 that any of the output queues need the data packet, the process moves to block 658. In block 658 it may be determined if any output queues that need the data packet are able to receive the data packet. In other words, it may be determined if at least one output queue needs and is able to receive the data packet. In block 660, if the determination is not true, meaning that no output queues that need the data packet are able to receive it, the process moves to block 662. In block 662, a response message may be sent to the source node indicating refusal of the request message. The refusal response may notify the source node that the request message needs to be sent again, as described above. The pull field in the response may be set to no to indicate that the data packet should not be sent to the destination node. The process moves to reference B, which has been described above with respect to FIG. 6(a), and the destination node may wait for the source node to resend the request message.

If it is determined in block 660 that at least one output queue needs and is able to receive the data packet, the process moves to block 664. In block 664 it may be determined if at least one output queue needs the data packet and all output queues that need the data packet are able to receive the data packet. If the determination in block 664 is true, in block 666 the process moves to block 668. In block 668 a response message indicating acceptance of the request message may be sent to the source node. The response message may include a pull field set to yes, to indicate that the data packet should be sent to the destination node. The data packet may be added to the output queues that need the data packet.

If the result of the determination in block 666 is not true, the process moves to block 670. In block 670 an attempt to allocate a pending request data structure may be made. It may also be determined if the allocation attempt is successful. In block 672 if the allocation is not successful, the process moves to reference C. As described above, a response indicating refusal of the request message may be sent with a pull field set to no. If the allocation of a pending request data structure is successful, the process moves to block 674.

In block 674 a response message may be sent to the source node indicating refusal of the request message with a pull field set to yes. The response indicates refusal, because at least one output queue is unable to receive the data packet, and as such, the request message may need to be resent. The pull field may be set to yes to indicate that the data packet should be sent to the destination node. When the data packet is received, the data packet may be added to the output queues that need and are able to receive the data packet. An indication of output queues that need but are unable to receive the data packet may be added to the pending request data structure. In some example implementations, an attempt may be made to maintain a local copy of the data packet. Regardless of the ability to maintain a local copy of the data packet, the process moves to reference B, wherein the destination awaits a resend of the request message.

We claim:

1. A method comprising:
receiving a request message, at a destination node, which identifies a data packet, wherein the data packet is associated with a pending request data structure;
retrieving, from the pending request data structure, an indication of output queues that are in need of the data packet;
determining, by the destination node, the indicated output queues that are able to receive the data packet; and
sending a response message to a source node indicating refusal of the request message if at least one output queue is unable to receive the data packet.

2. The method of claim 1 further comprising:
adding the data packet to the output queues that are able to receive the data packet; and
removing the indication of output queues that are in need of the data packet from the pending request data structure for output queues that are able to receive the request message.

3. The method of claim 2 further comprising:
sending a response message indicating acceptance of the request message if no output queues in the pending request data structure are indicated as needing the data packet.

4. The method of claim 2 wherein the data packet is added from memory on the destination node.

5. The method of claim 2 wherein the data packet is sent from the source node.

6. The method of claim 2 further comprising:
releasing the pending request data structure once no output queues are indicated as needing the data packet.

7. The method of claim 1 wherein the request message is received again if the response message indicates the request message is refused.

8. A method comprising:
receiving, at a destination node, a request message identifying a data packet that is not associated with a pending request data structure;
attempting to allocate the pending request data structure if at least two output queues need the data packet and at least one output queue is able and at least one output queue is unable to receive the data packet; and
if the allocation is successful:
sending the data packet from a source node and adding the data packet to the output queues that need and are able to receive the data packet; and
sending a response message to the source node indicating refusal of the request message.

9. The method of claim 8 further comprising:
sending a response message to the source node indicating refusal of the request message if the allocation fails.

10. The method of claim 8 further comprising storing, in the pending request data structure, an indication of output queues that need but are unable to receive the data packet.

11. The method of claim 8 further comprising:
sending the data packet from the source node and adding the data packet to the output queues that need the data packet if all output queues that need the data packet are able to receive the data packet; and
sending a response message to the source node indicating acceptance of the request message.

12. The method of claim 8 further comprising:
sending a response message indicating acceptance of the request message if no output queues need the data packet.

13. The method of claim 8 further comprising:
sending a response indicating refusal of the request message if at least one output queue needs the data packet and no output queue that needs the data packet is able to receive the data packet.

14. A device comprising:
a request module to receive a request message which identifies a data packet;
a pending request module to determine which output queues need the data packet and which output queues that need the data packet are able to receive the data packet; and
a response module to generate a response to the request message indicating refusal or acceptance of the request message based on the determination of the pending request module.

15. The device of claim 14 wherein the response indicates acceptance of the request message if:
no output queues need the data packet; or
all output queues that need the data packet are able to receive the data packet.

16. The device of claim 14 wherein the response indicates refusal of the request message if:
no output queues that need the data packet are able to receive the data packet; or
at least two output queues need the data packet, at least one output queue is able to receive the data packet, and at least one output queue is unable to receive the data packet.

17. The device of claim 16 wherein the device is an application specific integrated circuit.
